(19) United States
(12) Patent Application Publication
(10) Pub. No.: US 2025/0168770 A1
(43) Pub. Date: May 22, 2025

(54) METHOD AND APPARATUS FOR DETERMINING WHETHER TO MONITOR AND STORAGE MEDIUM

(71) Applicant: Beijing Xiaomi Mobile Software Co., Ltd., Beijing (CN)

(72) Inventor: Ting FU, Beijing (CN)

(21) Appl. No.: 18/729,666

(22) PCT Filed: Jan. 20, 2022
(86) PCT No.: PCT/CN2022/072884

§ 371 Date: Jul. 17, 2024

(51) Int. Cl. H04W 52/02

(52) U.S. Cl. CPC H04W 52/0235

(57) ABSTRACT

A method for determining whether to monitor is performed by a user device. The method includes: receiving information, sent by a network device, for indicating whether the user device monitors a wake up signal; and determining, based on the information, to monitor or not to monitor the wake up signal.

### CROSS-REFERENCE

The present application is a U.S. National Stage of International Application No. PCT/CN2022/072884, filed on Jan. 20, 2022, the entire content of which is incorporated herein by reference.

### TECHNICAL FIELD

The present disclosure relates to a field of wireless communication technology, and more particularly to a method for determining whether to monitor, an apparatus and a storage medium.

### BACKGROUND

In wireless communication technology, such as in 5th Generation Mobile Communication Technology (5G), a transceiver may be put into a sleep state in order to save power consumption of a User Equipment (UE).

The network device may send a multicast signal, which includes a wake up signal (WUS), and the same WUS may indicate a signal to a plurality of UEs. For example, the WUS includes 16 bits corresponding to 16 UEs, and each bit corresponds to one UE. When a corresponding bit of a UE is 1, it indicates wake-up, and the UE turns on a main transceiver for receiving a downlink signal: when the corresponding bit of the UE is 0, it indicates no wake-up, and the UE keeps the main transceiver in the sleep state.

How the UE determines whether it needs to monitor the WUS is an issue required to be addressed.

### SUMMARY

The present disclosure provides a monitoring method, an apparatus, and a readable storage medium.

In a first aspect, a method for determining whether to monitor is provided, the method is performed by a user device and includes:
receiving information, sent by a network device, for indicating whether the user device monitors a wake up signal; and
determining, based on the information, to monitor or not to monitor the wake up signal.

In a second aspect, a method for determining whether to monitor is provided, the method is performed by a network device and includes:
sending information for indicating whether a user device monitors a wake up signal.

In a third aspect, a communication apparatus is provided and includes a processor and a memory storing a computer program executable by the processor; and the processor is configured to perform the method according to the first aspect.

In a fourth aspect, a communication apparatus is provided and includes a processor and a memory storing a computer program executable by the processor; and the processor is configured to perform the method according to the second aspect.

It should be understood that the above general description and the following detailed description are merely exemplary and explanatory, and do not limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram of a wireless communication system architecture provided in an embodiment of the present disclosure;

FIG. 2 is a flowchart of a method for determining whether to monitor according to an embodiment;

FIG. 3 is a flowchart of a method for determining whether to monitor according to an embodiment;

FIG. 4 is a flowchart of a method for determining whether to monitor according to an embodiment;

FIG. 5 is a flowchart of a method for determining whether to monitor according to an embodiment;

FIG. 6 is a flowchart of a method for determining whether to monitor according to an embodiment;

FIG. 7 is a flowchart of a method for determining whether to monitor according to an embodiment;

FIG. 8 is a flowchart of a method for determining whether to monitor according to an embodiment;

FIG. 9 is a flowchart of a method for determining whether to monitor according to an embodiment;

FIG. 10 is a structural diagram of an apparatus for determining whether to monitor according to an embodiment;

FIG. 11 is a structural diagram of an apparatus for determining whether to monitor according to an embodiment;

FIG. 12 is a structural diagram of an apparatus for determining whether to monitor according to an embodiment;

FIG. 13 is a structural diagram of an apparatus for determining whether to monitor according to an embodiment.

### DETAILED DESCRIPTION

Example embodiments of the present disclosure are further described with reference to the accompanying drawings and the detailed description.

The embodiments are described in detail here, examples of which are illustrated in the accompanying drawings. When the following description involves the accompanying drawings, unless otherwise indicated, the same numbers in different drawings represent the same or similar elements. The embodiments described in the following embodiments do not represent all embodiments consistent with the embodiments of the present disclosure. On the contrary, they are merely examples of apparatus and methods consistent with some aspects of the present disclosure as detailed in the appended claims.

The terms used in the present disclosure are for the purpose of describing particular examples only, and are not intended to limit the present disclosure. Terms determined by “a,” “the” and “said” in their singular forms in the present disclosure and the appended claims are also intended to include plurality or multiple, unless clearly indicated otherwise in the context. It should also be understood that the term “and/or” as used herein is and includes any and all possible combinations of one or more of the associated listed items.

It should be understood that, although terms “first,” “second,” “third” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” and “whether” as used herein may be interpreted as “when” or “upon” or “in response to determining”.

The embodiments of the present disclosure are described in detail below. Examples of the embodiments are illustrated in the accompanying drawings where the same or similar numbers throughout indicate the same or similar elements. The embodiments described below by reference to the accompanying drawings are illustrative and are intended to interpret the present disclosure and are not to be construed as a limitation of the present disclosure.

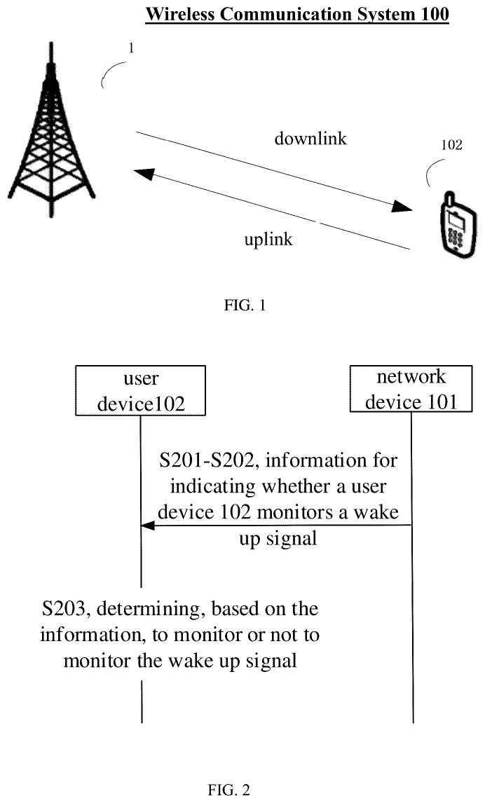

As shown in FIG. 1, a method for determining whether to monitor provided by embodiments of the present disclosure may be applied to a wireless communication system 100, which may include, but is not limited to, a network device 101 and a user device 102. The user device 102 is configured to support carrier aggregation, and the user device 102 may be connected to a plurality of carrier units of the network device 101, the plurality of carrier units including one primary carrier unit and one or more secondary carrier units.

It should be understood that the wireless communication system 100 may be applicable to both low frequency and high frequency scenarios. Application scenarios of the wireless communication system 100 include, but are not limited to, a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-generation (5G) system, a new radio (NR) communication system or a future evolution public land mobile network (PLMN) system, etc.

The user device 102 shown above may be user equipment (UE), a terminal, an access terminal, a terminal unit, a terminal station, a mobile station (MS), a remote station, a remote terminal, a mobile terminal, a wireless communication device, a terminal agent or a user device. The user device 102 may has a wireless transceiver function, and is capable of communicating (e.g., wirelessly communicating) with one or more network devices 101 of one or more communication systems, and accepting network service(s) provided by the network device(s) 101 including but not limited to the illustrated base station.

The user device 102 may be a cellular phone, a cordless phone, a session initiation protocol (SIP) phone, a wireless local loop (WLL) station, a personal digital assistant (PDA) device, a handheld device with a wireless communication capability, a computing device or other processing device connected to a wireless modem, an in-vehicle device, a wearable device, a user device in a future 5G network or a user device in a future evolution PLMN network.

The network device 101 may be an access network device (or referred to as an access network site). The access network device refers to a device providing a network access function, such as a radio access network (RAN) base station. The network device may specifically include a base station (BS) device, or include the base station device and a radio resource management device configured to control the base station device. The network device may further include a relay station (a relay device), an access point, and a base station in the future 5G network, a base station in the future evolution PLMN network, or an NR base station. The network device may be a wearable device or an in-vehicle device. The network device may also be a communication chip with a communication module.

For example, the network device 101 includes, but is not limited to, a next-generation base station (gnodeB, gNB) in 5G, an evolved node B (eNB) in the LTE system, a radio network controller (RNC), a node B (NB) in a wideband code division multiple access (WCDMA) system, a radio controller under the CRAN system, a base station controller (BSC), a base transceiver station (BTS) in a global system for mobile communications (GSM) or code division multiple access (CDMA) system, a home base station (for example, a home evolved nodeB, or a home node B (HNB)), a baseband unit (BBU), a transmitting and receiving point (TRP), a transmitting point (TP) or a mobile switching center.

Embodiments of the present disclosure provide a monitoring method, and FIG. 2 is a flowchart of a monitoring method according to an embodiment, as shown in FIG. 2. The method includes steps S201-203:

in step S201, a network device 101 sends information for indicating whether a user device 102 monitors a wake up signal to the user device 102:

in step S202, the user device 102 receives information, sent by network device 101, for indicating whether the user device monitors the wake up signal:

in step S203, the user device 102 determines to monitor or not to monitor the wake up signal based on the information.

In some embodiments, the user device 102 receives the information that is sent by the network device 101 for indicating that the user device 102 monitors the wake up signal, and based on the information, the user device 102 determines to monitor the wake up signal.

In some embodiments, the user device 102 receives information sent by network device 101 for indicating that the user device 102 does not monitor the wake up signal, and based on the information, the user device 102 determines not to monitor the wake up signal.

In the embodiment of the present disclosure, the network device indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

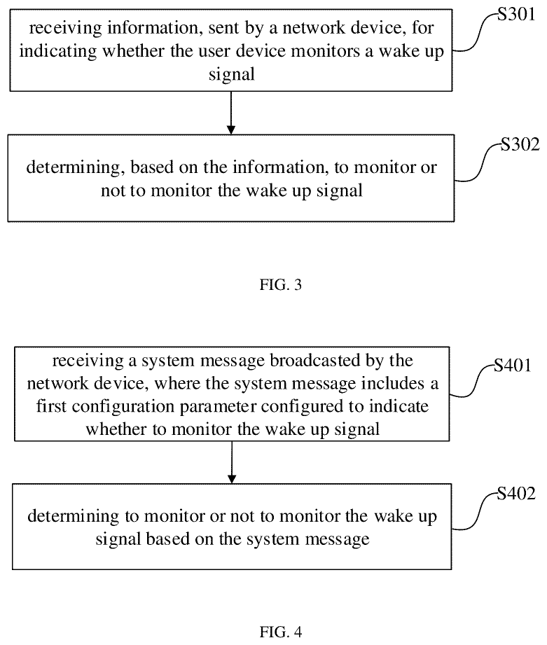

The embodiments of the present disclosure provide a monitoring method, which is performed by the user device 102. The method may be performed independently or in combination with any other embodiment of the embodiments of the present disclosure. FIG. 3 is a flowchart of a method for determining whether to monitor according to an embodiment, as shown in FIG. 3, the method includes steps S301-S302:

in step S301, information sent by a network device 101 for indicate whether a user device 102 monitors a wake up signal is received:

in step S302, it is determined to monitor or not to monitor the wake up signal based on the information.

In some embodiments, the user device 102 receives the information sent by the network device 101 for indicating that the user device 102 monitors the wake up signal, and based on the information, the user device 102 determines to monitor the wake up signal.

In some embodiments, the user device 102 receives the information sent by network device 101 for indicating that user device 102 does not monitor the wake up signal, and based on the information, the user device 102 determines not to monitor the wake up signal.

In the embodiments of the present disclosure, the network device indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

Embodiments of the present disclosure provide a monitoring method, which is performed by the user device 102. The method may be performed independently or in combination with any other embodiment of the embodiments of the present disclosure. FIG. 4 is a flowchart of a method for determining whether to monitor according to an embodiment, as shown in FIG. 4, and the method includes steps S401 and S402:
in step S401, a system message broadcasted by the network device is received, where the system message includes a first configuration parameter configured to indicate whether to monitor the wake up signal;
in step S402, it is determined to monitor or not to monitor the wake up signal based on the system message.

In some embodiments, the user device in steps S401 and S402 is in a Radio Resource Control (RRC) idle state.

In some embodiments, the system message broadcasted by the network device includes a plurality of first configuration parameters, and each first configuration parameter corresponds to one UE. For example, 16 bits in the system message are used for 16 first configuration parameters, and each bit corresponds to one UE. When a bit corresponding to the UE is 1, the corresponding first configuration parameter instruct to monitor the wake up signal, and the UE monitors the wake up signal; when a bit corresponding to the UE is 0, the corresponding first configuration parameter instructs not to monitor the wake up signal, and the UE does not monitor the wake up signal.

In the embodiment of the present disclosure, the network device indicates to the user device in an explicit manner whether to monitor the wake up signal, such that the user device determines to monitor or not to monitor the wake up signal according to the received indication, thereby improving the processing capability of the user device, and saving energy consumption of the user device when there is no need to monitor the wake up signal.

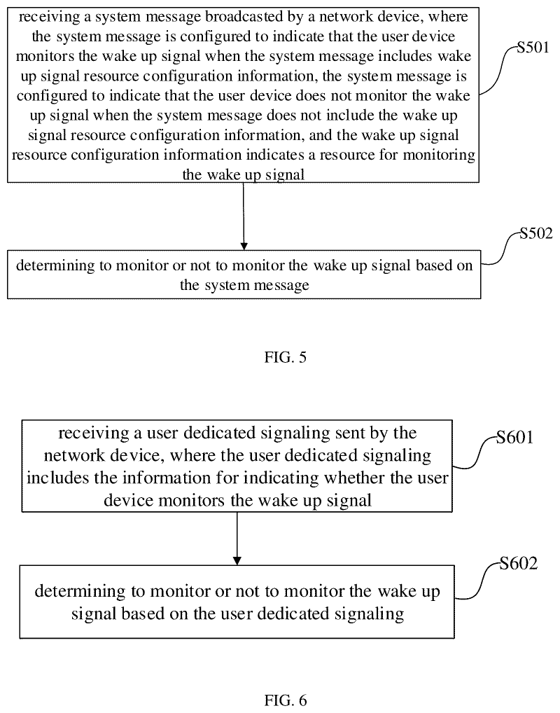

Embodiments of the present disclosure provide a monitoring method, performed by the user device 102. The method may be performed independently or in combination with any other embodiment of the embodiments of the present disclosure. FIG. 5 is a flowchart of a method for determining whether to monitor according to an embodiment, as shown in FIG. 5, and the method includes steps S501 and S502:
in step S501, a system message broadcasted by a network device 101 is received, where the system message is configured to indicate that the user device monitors the wake up signal when the system message includes wake up signal resource configuration information, the system message is configured to indicate that the user device does not monitor the wake up signal when the system message does not include the wake up signal resource configuration information, and the wake up signal resource configuration information indicates a resource for monitoring the wake up signal.
in step S502, it is determined to monitor or not to monitor the wake up signal based on the system message.

In some embodiments, the user device in steps S501 and S502 is in a Radio Resource Control (RRC) idle state.

In some embodiments, the resource for monitoring the wake up signal includes at least one of the following: a time-domain resource, a frequency-domain resource, or a code-domain resource.

In the above embodiments, the user device is in a Radio Resource Control (RRC) idle state.

In an embodiment of the present disclosure, the network device implicitly indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

Embodiments of the present disclosure provide a monitoring method, performed by a user device 102. FIG. 6 is a flowchart of a monitoring method according to an embodiment, as shown in FIG. 6, and the method includes steps S601 and S602:
in step S601, a user dedicated signaling sent by the network device is received, where the user dedicated signaling includes the information for indicating whether the user device monitors the wake up signal;
in step S602, it is determined to monitor or not to monitor the wake up signal based on the user dedicated signaling.

In some embodiments, the user device in steps S601 and S602 is in a Radio Resource Control (RRC) connected state.

In some embodiments, the user dedicated signaling is a dedicated signaling for each user, which may carry a unique identifier of the user.

Considering that SPS PDSCH is used for the UE in the RRC connected state to receive downlink data periodically sent. If the UE is configured with the SPS PDSCH resource, the UE may enable this channel to receive service data according to an activation indication sent by the network device, and stop using this channel according to a deactivation indication sent by the network device.

If the period (periodicity) of the SPS PDSCH is low and the main transceiver enters sleep state, the main transceiver needs to be woken up frequently to receive the downlink data from the SPS PDSCH, and in some cases, the transition time between sleep and wake up of the main transceiver is even longer than the period of SPS PDSCH. Therefore, it may be considered that when the UE is activated with the SPS PDSCH and the period of the SPS PDSCH is low, the UE does not need to enter the sleep state, only to maintain a working state, and thus there is no need to monitor the WUS signal.

A threshold value corresponding to the period of the SPS PDSCH may be a first threshold value, which is configured by the network device or specified by a protocol. The first threshold value is used to assist a user in determining whether to monitor the wake up signal. In some embodiments, the determination condition for the user device not monitoring the wake up signal at least includes: being activated with the SPS PDSCH, and the period of the SPS PDSCH being less than or equal to the first threshold value. In some embodiments, it is determined that the user device is configured with the resource for monitoring the wake up signal and is activated with the SPS PDSCH, and when the period of SPS PDSCH is less than or equal to the first threshold value, and it is determined that the user device does not monitor the wake up signal.

The setting of the first threshold value is related to the capabilities of the user device. In an example, if the capability of the user device is relatively capable, the main transceiver may be woken up quickly (e.g., 1 ms for the wake-up process), and a relatively low first threshold value, such as 2 ms, may be set. Thus, when the period of the SPS PDSCH is less than or equal to 2 ms, the main transceiver maintains in the working state. When the period of the SPS PDSCH is greater than 2 ms, the capability of the user device may support the main transceiver to continuously switch between sleep and working states in a relatively low period of the SPS PDSCH. If the capability of the user device is weak and the main transceiver cannot be woken up quickly (e.g., 5 ms for the wake-up process), a relatively great first threshold value, such as 10 ms, needs to be set. Thus, when the period of the SPS PDSCH is less than or equal to 10 ms, the user device needs to keep the main transceiver in the working state, while when the period of the SPS PDSCH is greater than 10 ms, the capability of the user device may support the main transceiver to continuously switch between sleep and working states.

In some embodiments, it also includes reporting first user device capability information to the network device, and the first user device capability information is configured to indicate a magnitude of the first threshold value desired by the user device.

In the embodiment of the present disclosure, the network device indicates to the user device in an explicit manner whether to monitor the wake up signal, such that the user device determines to monitor or not to monitor the wake up signal according to the received indication, thereby improving the processing capability of the user device, and saving energy consumption of the user device when there is no need to monitor the wake up signal.

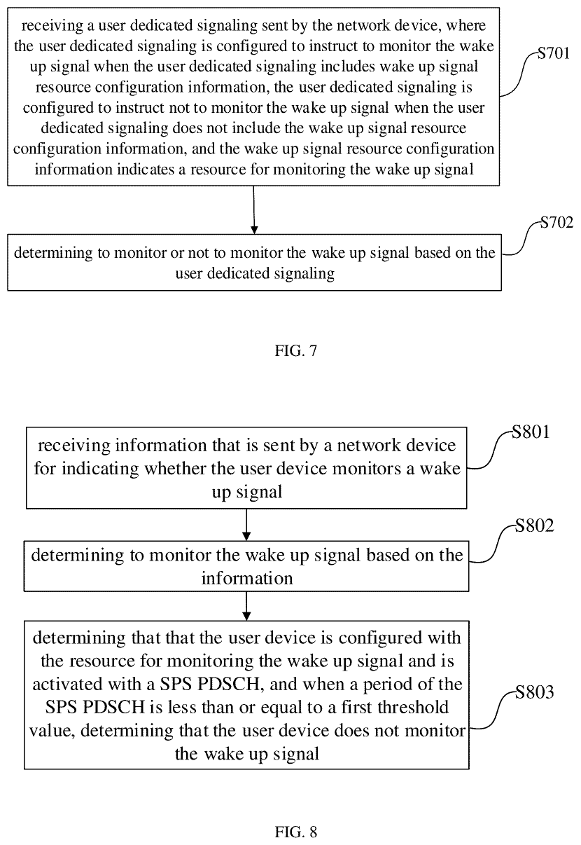

Embodiments of the present disclosure provide a monitoring method, performed by a user device 102. The method may be performed independently or in combination with any other embodiment of the embodiments of the present disclosure. FIG. 7 is a flowchart of a method for determining whether to monitor according to an embodiment, as shown in FIG. 7, the method includes steps S701 and S702:
in step S701, a user dedicated signaling sent by the network device is received, where the user dedicated signaling is configured to instruct to monitor the wake up signal when the user dedicated signaling includes wake up signal resource configuration information, the user dedicated signaling is configured to instruct not to monitor the wake up signal when the user dedicated signaling does not include the wake up signal resource configuration information, and the wake up signal resource configuration information indicates a resource for monitoring the wake up signal.
in step S702, it is determined to monitor or not to monitor the wake up signal based on the user dedicated signaling.

In some embodiments, the user device in steps S601 and S602 is in a Radio Resource Control (RRC) connected state.

In some embodiments, the resource for monitoring the wake up signal includes at least one of the following: a time-domain resource, a frequency-domain resource, or a code-domain resource.

Considering that SPS PDSCH is used for the UE in the RRC connected state to receive downlink data periodically sent. If the UE is configured with the SPS PDSCH resource, the UE may enable this channel to receive service data according to an activation indication sent by the network device, and stop using this channel according to a deactivation indication sent by the network device.

If the period of the SPS PDSCH is low and the main transceiver enters sleep state, the main transceiver needs to be woken up frequently to receive the downlink data from the SPS PDSCH, and in some cases, the transition time between sleep and wake up of the main transceiver is even longer than the period of SPS PDSCH. Therefore, it may be considered that when the UE is activated with the SPS PDSCH and the period of the SPS PDSCH is low, the UE does not need to enter the sleep state, only to maintain a working state, and thus there is no need to monitor the WUS signal.

A threshold value corresponding to the period of the SPS PDSCH may be a first threshold value, which is configured by the network device or specified by a protocol. The first threshold value is used to assist a user in determining whether to monitor the wake up signal. In some embodiments, the determination condition for the user device not monitoring the wake up signal at least includes: being activated with the SPS PDSCH, and the period of the SPS PDSCH being less than or equal to the first threshold value. In some embodiments, it is determined that the user device is configured with the resource for monitoring the wake up signal and is activated with the SPS PDSCH, and when the period of SPS PDSCH is less than or equal to the first threshold value, and it is determined that the user device does not monitor the wake up signal.

The setting of the first threshold value is related to the capabilities of the user device. In an example, if the capability of the user device is relatively capable, the main transceiver may be woken up quickly (e.g., 1 ms for the wake-up process), and a relatively low first threshold value, such as 2 ms, may be set. Thus, when the period of the SPS PDSCH is less than or equal to 2 ms, the main transceiver maintains in the working state. When the period of the SPS PDSCH is greater than 2 ms, the capability of the user device may support the main transceiver to continuously switch between sleep and working states in a relatively low period of the SPS PDSCH. If the capability of the user device is weak and the main transceiver cannot be woken up quickly (e.g., 5 ms for the wake-up process), a relatively great first threshold value, such as 10 ms, needs to be set. Thus, when the period of the SPS PDSCH is less than or equal to 10 ms, the user device needs to keep the main transceiver in the working state, while when the period of the SPS PDSCH is greater than 10 ms, the capability of the user device may support the main transceiver to continuously switch between sleep and working states.

In some embodiments, it also includes reporting first user device capability information to the network device, and the first user device capability information is configured to indicate a magnitude of the first threshold value desired by the user device.

In the embodiment of the present disclosure, the network device indicates to the user device in an implicit manner whether to monitor the wake up signal, such that the user device determines to monitor or not to monitor the wake up signal according to the received indication, thereby improving the processing capability of the user device, and saving energy consumption of the user device when there is no need to monitor the wake up signal.

Embodiments of the present disclosure provide a monitoring method, performed by a user device 102. The method may be performed independently or in combination with any other embodiment of the embodiments of the present disclosure. FIG. 8 is a flowchart of a method for determining whether to monitor according to an embodiment, as shown in FIG. 8, the method includes steps S801-S803:
in step S801, information that is sent by a network device for indicating whether the user device monitors a wake up signal is received;
in step S802, it is determined to monitor the wake up signal based on the information;
in step S803, it is determined that that the user device is configured with the resource for monitoring the wake up signal and is activated with a SPS PDSCH, and when a period of the SPS PDSCH is less than or equal to a first threshold value, it is determined that the user device does not monitor the wake up signal.

In some embodiments, the first threshold value is configured by the network device or specified by a protocol.

In some embodiments, the method further includes: reporting first user device capability information to the network device, where the first user device capability information is configured to indicate a magnitude of the first threshold value desired by the user device.

In some embodiments, the user device 102 is in an RRC idle state. In steps S801 and S802, the system message broadcasted by the network device is received, where the system message includes a first configuration parameter, wherein the first configuration parameter is configured to instruct to monitor the wake up signal, and the user device determines to monitor the wake up signal based on the system message.

In some embodiments, the user device 102 is in an RRC idle state. In steps S801 and S802, the system message broadcasted by the network device is received, where the system message includes the wake up signal resource configuration information, where the wake up signal resource configuration information indicates a resource for monitoring the wake up signal. The user device determines to monitor the wake up signal based on the system message.

In some embodiments, the user device is in an RRC connected state. In steps S801 and S802, the user device 102 receives the user dedicated signaling sent by the network device 101, and the user dedicated signaling includes the information for indicating that the user device monitors the wake up signal. The wake up signal resource configuration information indicates the resource for monitoring the wake up signal, and the user device determines to monitor the wake up signal based on the user dedicated signaling.

In some embodiments, the user device is in an RRC connected state, and in steps S801 and S802, a user dedicated signaling sent by the network device is received, where the user dedicated signaling includes wake up signal resource configuration information, where the wake up signal resource configuration information indicates a resource for monitoring the wake up signal. The user device determines to monitor the wake up signal based on the user dedicated signaling.

In some embodiments, the resource for monitoring the wake up signal includes at least one of the following: a time-domain resource, a frequency-domain resource, or a code-domain resource.

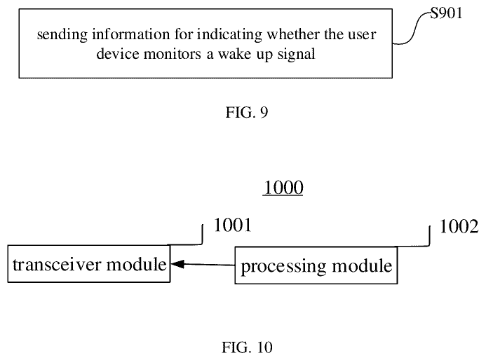

Embodiments of the present disclosure provide a monitoring method, performed by a network device 101. FIG. 9 is a flowchart of a monitoring method according to an embodiment, as shown in FIG. 9, the method includes step S901:
in step S901, information for indicating whether the user device 102 monitors a wake up signal is sent.

In the present embodiment, the network device indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

Embodiments of the present disclosure provide a monitoring method, performed by a network device 101, and the method includes:
broadcasting a system message, where the system message includes a first configuration parameter configured to indicate whether to monitor the wake up signal.

In some embodiments, the user device is in an RRC idle state.

Embodiments of the present disclosure provide a monitoring method, performed by a network device 101, and the method includes:
broadcasting a system message, where the system message is configured to instruct to monitor the wake up signal when the system message includes wake up signal resource configuration information, and the system message is configured to instruct not to monitor the wake up signal when the system message does not include the wake up signal resource configuration information, and the wake up signal resource configuration information indicates a resource for monitoring the wake up signal.

In some embodiments, the user device is in an RRC idle state.

In some embodiments, the resource for monitoring the wake up signal includes at least one of the following: a time-domain resource, a frequency-domain resource, or a code-domain resource.

Embodiments of the present disclosure provide a monitoring method, performed by a network device 101, and the method includes:
sending a dedicated signaling to the user device, where the dedicated signaling includes the information for indicating whether the user device monitors the wake up signal.

In some embodiments, the user device is in an RRC connected state.

In some embodiments, it also includes sending information for indicating a first threshold value to the user device, where the first threshold value is configured to assist a user in determining whether to monitor the wake up signal. When the user device uses the first threshold value, it is determined that the user device is configured with the resource for monitoring the wake up signal and is activated with the SPS PDSCH, and when the period of SPS PDSCH is less than or equal to the first threshold value, and it is determined that the user device does not monitor the wake up signal.

In some embodiments, it also includes reporting first user device capability information to the network device, where the first user device capability information is configured to indicate a magnitude of the first threshold value desired by the user device.

Embodiments of the present disclosure provide a monitoring method, performed by a network device 101, and the method includes:
sending a dedicated signaling to the user device, where the user dedicated signaling is configured to instruct to monitor the wake up signal when the user dedicated signaling includes wake up signal resource configuration information, the user dedicated signaling is configured to instruct not to monitor the wake up signal when the user dedicated signaling does not include the wake up signal resource configuration information, and the wake up signal resource configuration information indicates a resource for monitoring the wake up signal.

In some embodiments, the user device is in an RRC connected state.

In some embodiments, the resource for monitoring the wake up signal include at least one of the following: a time-domain resource, a frequency-domain resource, or a code-domain resource.

In some embodiments, it also includes sending information for indicating a first threshold value to the user device, and the first threshold value is configured to assist a user in determining whether to monitor the wake up signal. When the user device uses the first threshold value, it is determined that the user device is configured with the resource for monitoring the wake up signal and is activated with the SPS PDSCH, and when the period of SPS PDSCH is less than or equal to the first threshold value, and it is determined that the user device does not monitor the wake up signal.

In some embodiments, it also includes reporting first user device capability information to the network device, where the first user device capability information is configured to indicate a magnitude of the first threshold value desired by the user device.

Based on the same concept as the above method embodiments, embodiments of the present disclosure also provide a communication apparatus that may have a function of the user device 102 in the above method embodiments and be configured to perform steps provided by the user device 102 in the above embodiments. The function may be implemented in a form of hardware, in a form of software or in a form of hardware executing corresponding software. The hardware or software includes one or more modules corresponding to the function described above.

In an embodiment, the communication apparatus 1000 shown in FIG. 10 may serve as the user device 102 involved in the above method embodiments and perform the steps performed by the user device 102 in the above method embodiments.

The communication apparatus 1000 includes:
a transceiver module 1001, configured to receive information, sent by a network device 101, for indicating whether the user device 102 monitors a wake up signal;
a processing module 1002, configured to determine to monitor or not to monitor the wake up signal based on the received indication information sent by the network device.

In some embodiments, the transceiver module 1001 is further configured to receive a system message broadcasted by the network device, where the system message includes a first configuration parameter configured to indicate whether to monitor the wake up signal.

In some embodiments, the transceiver module 1001 is further configured to receive a system message broadcasted by the network device, where the system message is configured to instruct to monitor the wake up signal when the system message includes wake up signal resource configuration information, the system message is configured to instruct not to monitor the wake up signal when the system message does not include the wake up signal resource configuration information, and the wake up signal resource configuration information indicates a resource for monitoring the wake up signal.

In some embodiments, the user device is in an RRC idle state.

In some embodiments, the transceiver module 1001 may further configured to receive a user dedicated signaling sent by the network device, where the user dedicated signaling includes the information for indicating whether the user device monitors the wake up signal.

In some embodiments, the transceiver module 1001 is further configured to receive a user dedicated signaling sent by the network device, where the user dedicated signaling is configured to instruct to monitor the wake up signal when the user dedicated signaling includes wake up signal resource configuration information, the user dedicated signaling is configured to instruct not to monitor the wake up signal when the user dedicated signaling does not include the wake up signal resource configuration information, and the wake up signal resource configuration information indicates a resource for monitoring the wake up signal.

In some embodiments, the user device is in an RRC connected state.

In some embodiments, the resource for monitoring the wake up signal includes at least one of the following: a time-domain resource, a frequency-domain resource, or a code-domain resource.

In some embodiments, the processing module 1002 is further configured to determine that the user device is configured with the resource for monitoring the wake up signal and is activated with a SPS PDSCH, and when a period of the SPS PDSCH is less than or equal to a first threshold value, to determine that the user device does not monitor the wake up signal.

In some embodiments, the first threshold value is configured by the network device or specified by a protocol.

In some embodiments, the transceiver module 1001 is also configured to report first user device capability information to the network device, the first user device capability information is configured to indicate a magnitude of the first threshold value desired by the user device.

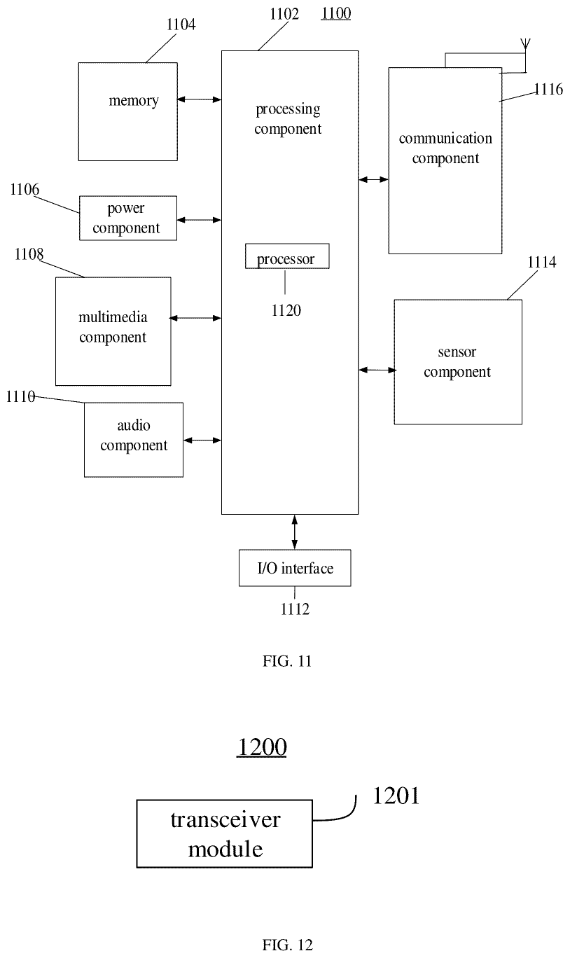

When the communication apparatus is a user device, its structure may also be shown in FIG. 11. FIG. 11 is a block diagram of an apparatus 1100 for determining whether to monitor, according to an embodiment. For example, the apparatus 1100 may be a mobile phone, a computer, a digital broadcast terminal, a message transceiver, a game console, a tablet device, a medical device, fitness equipment, a personal digital assistant or the like.

Referring to FIG. 11, the apparatus 1100 may include one or more following components: a processing component 1102, a memory 1104, a power component 1106, a multimedia component 1108, an audio component 1110, an input/output (I/O) interface 1112, a sensor component 1114 and a communication component 1116.

The processing component 1102 typically controls overall operations of the apparatus 1100, such as the operations associated with display, telephone calls, data communications, camera operations and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For example, the processing component 1102 may include a multimedia module to facilitate the interaction between the multimedia component 1108 and the processing component 1102.

The memory 1104 is configured to store various types of data to support the operation of the apparatus 1100. Examples of such data include instructions for any applications or methods operated on the apparatus 1100, contact data, phonebook data, messages, pictures, video, etc. The memory 1104 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the apparatus 1100. The power component 1106 may include a power management system, one or more power sources, and any other components associated with the generation, management, and distribution of power in the apparatus 1100.

The multimedia component 1108 includes a screen providing an output interface between the apparatus 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes and gestures on the touch panel. The touch sensors may not only sense a boundary of a touch or swipe action, but also sense a period of time and a pressure associated with a touch or swipe action. In some embodiments, the multimedia component 1108 includes a front camera and/or a rear camera. The front camera and/or the rear camera may receive an external multimedia datum while the apparatus 1100 is in an operation mode, such as a photographing mode or a video mode. Each of the front and rear cameras may be a fixed optical lens system or have a focus and optical zoom capability.

The audio component 1110 is configured to output and/or input audio signals. For example, the audio component 1110 includes a microphone (MIC) configured to receive an external audio signal when the apparatus 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button. The buttons may include, but are not limited to, a home button, a volume button, a starting button, and a locking button.

The sensor component 1114 includes one or more sensors to provide status assessments of various aspects of the apparatus 1100. For instance, the sensor component 1114 may detect an open/closed status of the apparatus 1100, relative positioning of components, e.g., the display and the keypad, of the apparatus 1100, a change in position of the apparatus 1100 or a component of the apparatus 1100, a presence or absence of user's contact with the apparatus 1100, an orientation or an acceleration/deceleration of the apparatus 1100, and a change in temperature of the apparatus 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor or a temperature sensor.

The communication component 1116 is configured to facilitate communication, wired or wirelessly, between the apparatus 1100 and other devices. The apparatus 1100 can access a wireless network based on a communication standard, such as WiFi, 4G; or 5G; or a combination thereof. In one embodiment, the communication component 1116 receives a broadcast signal or broadcast associated information from an external broadcast management system via a broadcast channel. In one embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In embodiments, the apparatus 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In embodiments, there is also provided a non-transitory computer-readable storage medium comprising instructions, such as included in the memory 1104, executable by the processor 1120 in the apparatus 1100, for performing the above-described methods. For example, the non-transitory computer-readable storage medium may be a ROM, a RAM, a CD-ROM, a magnetic tape, a floppy disc, an optical data storage device, and the like.

Based on the same concept as the above method embodiments, embodiments of the present disclosure also provide a communication apparatus that may have a function of the network device 101 in the above method embodiments and be configured to perform steps provided by the network device 101 in the above embodiments. The function may be implemented in a form of hardware, in a form of software or in a form of hardware executing corresponding software. The hardware or software includes one or more modules corresponding to the function described above.

In an embodiment, the communication apparatus 1200 shown in FIG. 12 may serve as the network device 101 involved in the above method embodiments and perform the steps performed by the network device 101 in the above method embodiments.

The communication apparatus 1200 includes a transceiver module 1201, configured to send information for indicating whether a user device monitors a wake up signal.

In an embodiment, the transceiver module 1201 is further configured to broadcast a system message, where the system message includes a first configuration parameter configured to indicate whether to monitor the wake up signal.

In an embodiment, the transceiver module 1201 is further configured to broadcast a system message, where the system message is configured to instruct to monitor the wake up signal when the system message includes wake up signal resource configuration information, and the system message is configured to instruct not to monitor the wake up signal when the system message does not include the wake up signal resource configuration information, and the wake up signal resource configuration information indicates a resource for monitoring the wake up signal.

In an embodiment, the user device is in an RRC idle state.

In an embodiment, the transceiver module 1201 is further configured to send a dedicated signaling to the user device, where the dedicated signaling includes the information for indicating whether the user device monitors the wake up signal.

In an embodiment, the transceiver module 1201 is further configured to send a dedicated signaling to the user device, where the user dedicated signaling is configured to instruct to monitor the wake up signal when the user dedicated signaling includes wake up signal resource configuration information, the user dedicated signaling is configured to instruct not to monitor the wake up signal when the user dedicated signaling does not include the wake up signal resource configuration information, and the wake up signal resource configuration information indicates a resource for monitoring the wake up signal.

In an embodiment, the user device is in an RRC connected state.

In an embodiment, the resource for monitoring the wake up signal includes at least one of the following: a time-domain resource, a frequency-domain resource, or a code-domain resource.

In an embodiment, the transceiver module 1201 is further configured to send information for indicating a first threshold value to the user device, and the first threshold value is configured to assist a user in determining whether to monitor the wake up signal.

In an embodiment, the transceiver module 1201 is further configured to receive first user device capability information reported by the user device, where the first user device capability information is configured to indicate a magnitude of the first threshold value desired by the user device.

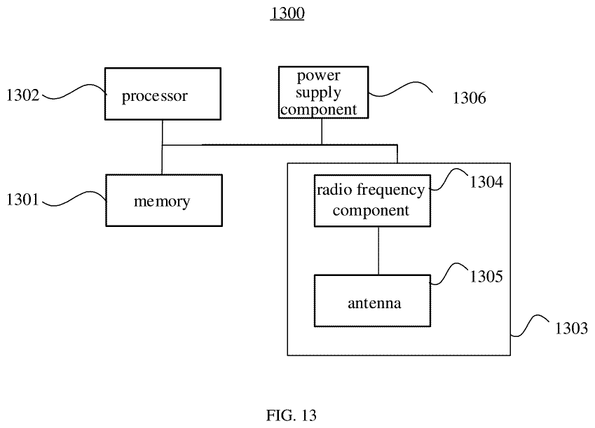

When the communication apparatus is the network device, its structure may also be as shown in FIG. 13. The configuration of the communication apparatus will be described by taking a base station as an example. As shown in FIG. 13, the apparatus 1300 includes a memory 1301, a processor 1302, a transceiver component 1303, and a power supply component 1306. The memory 1301 is coupled with the processor 1302, and may be used to store programs and data necessary for the communication apparatus 400 to realize various functions. The processor 1302 is configured to support the communication apparatus 400 to perform the corresponding functions in the above-mentioned methods, and the functions may be implemented by calling programs stored in the memory 1301. The transceiver component 1303 may be a wireless transceiver, and may be used to support the communication apparatus 400 to receive signaling and/or data through a wireless air interface, and to transmit signaling and/or data. The transceiver component 1303 may also be referred to as a transceiver unit or a communication unit, and the transceiver component 1303 may include a radio frequency component 1304 and one or more antennas 1305, where the radio frequency component 1304 may be a remote radio unit (RRU), specifically, it may be used for the transmission of radio frequency signals and the conversion of radio frequency signals and baseband signals, and the one or more antennas 1305 may be specifically used for radiation and reception of radio frequency signals.

When the communication apparatus 1300 needs to send data, the processor 1302 may perform baseband processing on the data to be sent, and then output the baseband signal to the radio frequency unit, and the radio frequency unit performs radio frequency processing on the baseband signal and sends the radio frequency signal through the antenna in the form of electromagnetic waves. When data is sent to the communication apparatus 1300, the radio frequency unit receives the radio frequency signal through the antenna, converts the radio frequency signal into a baseband signal, and outputs the baseband signal to the processor 1302, and the processor 1302 converts the baseband signal into data and processes the data.

In a first aspect, a method for determining whether to monitor is provided, the method is performed by a user device and includes:
receiving information, sent by a network device, for indicating whether the user device monitors a wake up signal; and
determining, based on the information, to monitor or not to monitor the wake up signal.

In the present method, the network device indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

In some embodiments, the receiving the information, sent by the network device, for indicating whether the user device monitors the wake up signal includes:
receiving a system message broadcasted by the network device, where the system message includes a first configuration parameter configured to indicate whether to monitor the wake up signal.

In the present method, the network device indicates to the user device in an explicit manner whether to monitor the wake up signal, such that the user device determines to monitor or not to monitor the wake up signal according to the received indication, thereby improving the processing capability of the user device, and saving energy consumption of the user device when there is no need to monitor the wake up signal.

In some embodiments, the receiving the information, sent by the network device, for indicating whether the user device monitors the wake up signal includes:
receiving a system message broadcasted by the network device, where the system message is configured to instruct to monitor the wake up signal when the system message includes wake up signal resource configuration information, the system message is configured to instruct not to monitor the wake up signal when the system message does not include the wake up signal resource configuration information, and the wake up signal resource configuration information indicates a resource for monitoring the wake up signal.

In the present method, the network device implicitly indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

In some embodiments, the user device is in an RRC idle state.

In some embodiments, the receiving the information, sent by the network device, for indicating whether the user device monitors the wake up signal includes:
receiving a user dedicated signaling sent by the network device, where the user dedicated signaling includes the information for indicating whether the user device monitors the wake up signal.

In the present method, the network device indicates to the user device in an explicit manner whether to monitor the wake up signal, such that the user device determines to monitor or not to monitor the wake up signal according to the received indication, thereby improving the processing capability of the user device, and saving energy consumption of the user device when there is no need to monitor the wake up signal.

In some embodiments, the receiving the information, sent by the network device, for indicating whether the user device monitors the wake up signal includes:
receiving a user dedicated signaling sent by the network device, where the user dedicated signaling is configured to instruct to monitor the wake up signal when the user dedicated signaling includes wake up signal resource configuration information, the user dedicated signaling is configured to instruct not to monitor the wake up signal when the user dedicated signaling does not include the wake up signal resource configuration information, and the wake up signal resource configuration information indicates a resource for monitoring the wake up signal.

In the present method, the network device implicitly indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

In some embodiments, the user device is in an RRC connected state.

In some embodiments, the resource for monitoring the wake up signal includes at least one of the following: a time-domain resource, a frequency-domain resource, or a code-domain resource.

In some embodiments, the method further includes:
determining that the user device is configured with the resource for monitoring the wake up signal and is activated with a semi-persistent scheduling physical downlink shared channel, SPS PDSCH, and when a period of the SPS PDSCH meets a first relationship, determining that the user device does not monitor the wake up signal.

In some embodiments, the first relationship includes: the period of the SPS PDSCH being less than or equal to a first threshold value.

In some embodiments, the first threshold value is configured by the network device or specified by a protocol.

In some embodiments, the method further includes: reporting first user device capability information to the network device, where the first user device capability information is configured to indicate a magnitude of the first threshold value desired by the user device.

In a second aspect, a method for determining whether to monitor is provided, the method is performed by a network device and includes:
sending information for indicating whether a user device monitors a wake up signal.

In the present method, the network device indicates to the user device whether to monitor the wake up signal, such that the user device determines to monitor or not to monitor the wake up signal according to the received indication, thereby improving the processing capability of the user device, and saving energy consumption of the user device when there is no need to monitor the wake up signal.

In some embodiments, the sending the information for indicating whether the user device monitors the wake up signal includes:
broadcasting a system message, where the system message includes a first configuration parameter configured to indicate whether to monitor the wake up signal.

In some embodiments, the sending the information for indicating whether the user device monitors the wake up signal includes:
broadcasting a system message, where the system message is configured to instruct to monitor the wake up signal when the system message includes wake up signal resource configuration information, and the system message is configured to instruct not to monitor the wake up signal when the system message does not include the wake up signal resource configuration information, and the wake up signal resource configuration information indicates a resource for monitoring the wake up signal.

In some embodiments, the user device is in an RRC idle state.

In some embodiments, the sending the information for indicating whether the user device monitors the wake up signal includes:
sending a dedicated signaling to the user device, where the dedicated signaling includes the information for indicating whether the user device monitors the wake up signal.

17. The method according to claim 12, where the sending the information for indicating whether the user device monitors the wake up signal includes:
sending a dedicated signaling to the user device, where the user dedicated signaling is configured to instruct to monitor the wake up signal when the user dedicated signaling includes wake up signal resource configuration information, the user dedicated signaling is configured to instruct not to monitor the wake up signal when the user dedicated signaling does not include the wake up signal resource configuration information, and the wake up signal resource configuration information indicates a resource for monitoring the wake up signal.

In some embodiments, the user device is in an RRC connected state.

In some embodiments, the resource for monitoring the wake up signal includes at least one of the following:
a time-domain resource, a frequency-domain resource, or a code-domain resource.

In some embodiments, the method further includes: sending information for indicating a first threshold value to the user device, where the first threshold value is configured to assist a user in determining whether to monitor the wake up signal.

In some embodiments, the method further includes: receiving first user device capability information reported by the user device, where the first user device capability information is configured to indicate a magnitude of the first threshold value desired by the user device.

In a third aspect, a communication apparatus is provided, the communication apparatus may be used to perform the method according to the first aspect. The user device may implement each of the functions in each of the above methods in the form of a hardware structure, a software module or a hardware structure plus a software module.

In implementing the communication apparatus shown in the first aspect by means of a software module, the communication apparatus may include a transceiver module and a processing module.
the transceiver module is configured to receive information, sent by a network device, for indicating whether the user device monitors a wake up signal;
a processing module is configured to determine to monitor or not to monitor the wake up signal based on the information.

In a fourth aspect, a communication apparatus is provided, the communication apparatus may be used to perform the method according to the second aspect. The network device may implement each of the functions in each of the above methods in the form of a hardware structure, a software module or a hardware structure plus a software module.

In implementing the communication apparatus shown in the second aspect by means of a software module, the communication apparatus may include a transceiver module.
the transceiver module is configured to send information for indicating whether a user device monitors a wake up signal.

In a fifth aspect, a communication apparatus is provided and includes a processor and a memory, the memory is configured to store a computer program; and the processor is configured to perform the method according to the first aspect.

In a sixth aspect, a communication apparatus is provided and includes a processor and a memory, the memory is configured to store a computer program; and the processor is configured to perform the method according to the second aspect.

In a seventh aspect, a non-transitory computer-readable storage medium is provided, the computer-readable storage medium has instructions (or computer programs, programs) stored thereon, when the instructions are executed by a processor, the processor is caused to perform the method according to the first aspect.

In an eighth aspect, a non-transitory computer-readable storage medium is provided, the computer-readable storage medium has instructions (or computer programs, programs) stored thereon, when the instructions are executed on a processor, the processor is caused to perform the method according to the second aspect.

Other embodiments of the present disclosure will be apparent to those skilled in the art from consideration of the specification and practice of the present disclosure disclosed here. The present disclosure is intended to cover any variations, uses, or adaptations of the embodiments of the present disclosure following the general principles thereof and including such departures from the embodiments of the present disclosure as come within known or customary practice in the art. It is intended that the specification and examples be considered as exemplary only, with a true scope and spirit of the embodiments of the present disclosure being indicated by the following claims.

It will be appreciated that the embodiments of the present disclosure is not limited to the exact construction that has been described above and illustrated in the accompanying drawings, and that various modifications and changes can be made without departing from the scope thereof. It is intended that the scope of the embodiments of the present disclosure only be limited by the appended claims.

### INDUSTRIAL APPLICABILITY

The network device indicates to the user device whether to monitor the wake up signal, such that the user device determines to monitor or not to determine the wake up signal according to the received indication, thereby improving the processing capability of the user device, and saving energy consumption when there is no need to monitor the wake up signal.

1. A method for determining whether to monitor, performed by a user device, comprising:
receiving information, sent by a network device, for indicating whether the user device monitors a wake up signal; and
determining, based on the information, to monitor or not to monitor the wake up signal.

2. The method according to claim 1, wherein the receiving the information, sent by the network device, for indicating whether the user device monitors the wake up signal comprises:
receiving a system message broadcasted by the network device, wherein the system message comprises a first configuration parameter configured to indicate whether to monitor the wake up signal.

3. The method according to claim 1, wherein the receiving the information, sent by the network device, for indicating whether the user device monitors the wake up signal comprises:
receiving a system message broadcasted by the network device, wherein the system message is configured to instruct to monitor the wake up signal in a case that the system message comprises wake up signal resource configuration information, the system message is configured to instruct not to monitor the wake up signal in a case that the system message does not comprise the wake up signal resource configuration information, and the wake up signal resource configuration information indicates a resource for monitoring the wake up signal.

4. The method according to claim 2, wherein the user device is in a Radio Resource Control (RRC) idle state.

5. The method according to claim 1, wherein the receiving the information, sent by the network device, for indicating whether the user device monitors the wake up signal comprises:
receiving a user dedicated signaling sent by the network device, wherein the user dedicated signaling comprises the information for indicating whether the user device monitors the wake up signal.

6. The method according to claim 1, wherein the receiving the information, sent by the network device, for indicating whether the user device monitors the wake up signal comprises:
receiving a user dedicated signaling sent by the network device, wherein the user dedicated signaling is configured to instruct to monitor the wake up signal in a case that the user dedicated signaling comprises wake up signal resource configuration information, the user dedicated signaling is configured to instruct not to monitor the wake up signal in a case that the user dedicated signaling does not comprise the wake up signal resource configuration information, and the wake up signal resource configuration information indicates a resource for monitoring the wake up signal.

7. The method according to claim 5, wherein the user device is in a Radio Resource Control (RRC) connected state.

8. The method according to claim 3, wherein the resource for monitoring the wake up signal comprises at least one of:
a time-domain resource,
a frequency-domain resource, or
a code-domain resource.

9. The method according to claim 5, further comprising:
determining that the user device is configured with the resource for monitoring the wake up signal and is activated with a semi-persistent scheduling physical downlink shared channel (SPS PDSCH), and
in response to a period of the SPS PDSCH being less than or equal to a first threshold value, determining that the user device does not monitor the wake up signal.

10. The method according to claim 9, wherein the first threshold value is configured by the network device or specified by a protocol.

11. The method according to claim 9, further comprising:
reporting first user device capability information to the network device, wherein the first user device capability information is configured to indicate a magnitude of the first threshold value desired by the user device.

12. A method for determining whether to monitor, performed by a network device, comprising:
sending information for indicating whether a user device monitors a wake up signal.

13. The method according to claim 12, wherein the sending the information for indicating whether the user device monitors the wake up signal comprises:
broadcasting a system message, wherein the system message comprises a first configuration parameter configured to indicate whether to monitor the wake up signal.

14. The method according to claim 12, wherein the sending the information for indicating whether the user device monitors the wake up signal comprises:
broadcasting a system message, wherein the system message is configured to instruct to monitor the wake up signal in a case that the system message comprises wake up signal resource configuration information, and the system message is configured to instruct not to monitor the wake up signal in a case that the system message does not comprise the wake up signal resource configuration information, and the wake up signal resource configuration information indicates a resource for monitoring the wake up signal.

15. (canceled)

16. The method according to claim 12, wherein the sending the information for indicating whether the user device monitors the wake up signal comprises:
sending a user dedicated signaling to the user device, wherein the user dedicated signaling comprises the information for indicating whether the user device monitors the wake up signal.

17. The method according to claim 12, wherein the sending the information for indicating whether the user device monitors the wake up signal comprises:
sending a user dedicated signaling to the user device, wherein the user dedicated signaling is configured to instruct to monitor the wake up signal in a case that the user dedicated signaling comprises wake up signal resource configuration information, the user dedicated signaling is configured to instruct not to monitor the wake up signal in a case that the user dedicated signaling does not comprise the wake up signal resource configuration information, and the wake up signal resource configuration information indicates a resource for monitoring the wake up signal.

18. (canceled)

19. (canceled)

20. The method according to claim 16, further comprising:
sending information for indicating a first threshold value to the user device, wherein the first threshold value is configured to assist a user in determining whether to monitor the wake up signal.

21. The method according to claim 20, further comprising:
receiving first user device capability information reported by the user device, wherein the first user device capability information is configured to indicate a magnitude of the first threshold value desired by the user device.

22.-33. (canceled)

34. A communication apparatus, comprising:
a processor; and
a memory storing a computer program executable by the processor;
wherein the processor is configured to:
receive information, sent by a network device, for indicating whether a user device monitors a wake up signal; and
determine, based on the information, to monitor or not to monitor the wake up signal.

35. A communication apparatus, comprising:
a processor; and
a memory storing a computer program executable by the processor;
wherein the processor is configured to perform the method according to claim 12.

36. (canceled)

37. (canceled)
